(19) United States
(12) Patent Application Publication
(10) Pub. No.: US 2015/0154093 A1
(43) Pub. Date: Jun. 4, 2015

(54) DEBUG CIRCUITRY

(71) Applicant: STMicroelectronics (Research & Development) Limited, Marlow (GB)

(72) Inventor: Gavin Probyn, Swindon (GB)

(73) Assignee: STMicroelectronics (Research & Development) Limited, Marlow (GB)

(21) Appl. No.: 14/551,292

(22) Filed: Nov. 24, 2014

(30) Foreign Application Priority Data
Nov. 29, 2013 (GB) 1321056.2

(51) Int. Cl. G06F 11/26; G06F 11/30

(52) U.S. Cl. CPC G06F 11/26; G06F 11/3089

(57) ABSTRACT

A debug circuitry includes a first interface configured to receive at least one operational transaction. The debug circuitry further includes a second interface configured to provide an output. Transaction manipulation circuitry operates to manipulate the at least one operational transaction to provide a manipulated operational transaction output passed to the second interface as the output.

### PRIORITY CLAIM

This application claims priority from Great Britain Application for Patent No. 1321056.2 filed Nov. 29, 2013, the disclosure of which is incorporated by reference.

### TECHNICAL FIELD

Some embodiments may relate to debug circuitry which in some embodiments may be provided in an integrated circuit or die.

### BACKGROUND

System on chip devices (SOCs) may have various circuitry blocks, bus interfaces, memory devices, and one or more system busses for communicating information. When designing, testing, and checking the system on chip device, it is usual to operate the system in a mode so that problems with, for example, programs executing on one or more of the circuitry blocks, can be identified and corrected. This process of problem identification and correction is sometimes referred to as debugging.

### SUMMARY

According to one aspect, there is provided debug circuitry comprising: a first interface configured to receive at least one transaction; a second interface configured to provide an output; and transaction manipulation circuitry configured to manipulate said at least one transaction to provide a manipulated transaction output to said second interface, said manipulated transaction output comprising said output.

The transaction manipulation circuitry may be configured to change a timing of said at least one transaction.

The transaction manipulation circuitry may be configured to one of pause said at least transaction and delay said at least one transaction.

The transaction manipulation circuitry may be configured to add an end of transaction termination signal to said transaction.

The transaction manipulation circuitry may be configured to change at least one of an address or data content of said transaction.

The transaction manipulation circuitry may be configured to add dummy transaction information to said transaction.

The dummy transaction information may comprise dummy data and associated information.

The second interface may be configured to receive at least one response transaction, said transaction modification circuitry is configured to modify the response transaction to provide a modified response transaction to said first interface, said first interface being configured to output said modified response transaction.

The transaction modification circuitry may be configured to modify the response transaction to remove a response to said dummy transaction information.

The transaction manipulation circuitry may be configured to in one mode of operation to pass the at least one transaction with no manipulation to the second interface.

The debug circuitry may comprise an input configured to receive configuration information for configuring said debug circuitry.

The debug circuitry may comprise an output configured to output debug information for test equipment.

According to another aspect, there is provided a die or integrated circuit comprising debug circuitry, as described previously.

The die or integrated circuit may further comprise an interconnect, a transaction source and a destination for said manipulated transaction output.

The debug circuitry may be provided in a path between said transaction source and said interconnect.

The debug circuitry may be provided in a path between said interconnect and a destination for said manipulated transaction output.

### BRIEF DESCRIPTION OF THE DRAWINGS

Some embodiments will now be described, by way of example only, to the accompanying drawings in which:

FIG. 1 shows an interface between a system on chip block and an interface node;

FIG. 2 shows an embodiment having a debug block in the interface between a the system on chip block and the interface node;

FIG. 3A schematically shows a system of a first embodiment;

FIG. 3B schematically shows a system of a second embodiment;

FIG. 4 schematically shows the debug block in more detail;

FIGS. 5A to 5C are timing diagrams illustrating a transaction closing mode of the debug block;

FIGS. 6A and 6B are timing diagrams illustrating a transaction delaying mode of the debug block;

FIG. 7 is a timing diagram illustrating a data modifying mode of the debug block;

FIG. 8 is a timing diagram illustrating a mode in which request cells are added and response cells are masked; and

FIG. 9 shows a device.

### DETAILED DESCRIPTION OF THE DRAWINGS

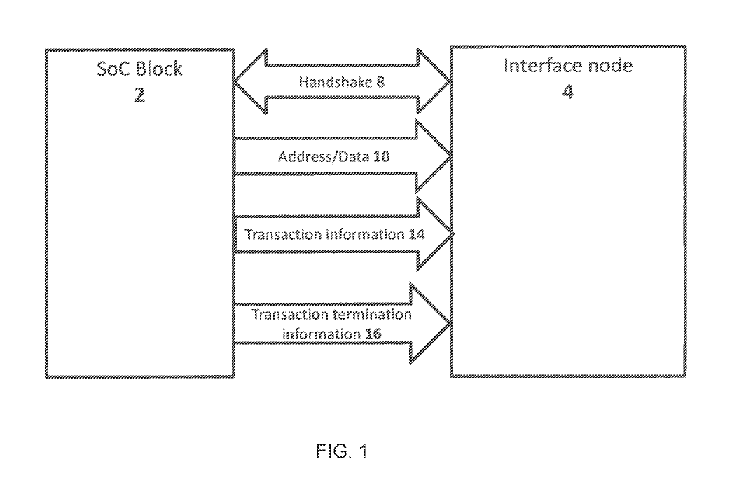

Reference is made to FIG. 1 which schematically shows an interface 1 between a system on chip (SoC) block 2 and an interface node 4. The interface node 4 may be a system on chip interconnect node or interface node to any suitable interconnect. The interface may be provided on an integrated circuit or die or may be provided off chip. The interconnect may be, for example, a bus or a network on chip.

The system on chip block can be any suitable circuitry.

The system on chip block 2 and the interface node 4 communicate via operational transactions. These may be understood as transactions that are issued between the two blocks during normal working operation of the circuitry to perform a function beyond simply monitoring the circuitry's functionality. In other words, they may be understood as transactions that, at least in part, achieve the function for which the circuitry was created. As examples only, operational transactions may include memory transactions, or control signals.

In the embodiment to be described, the system on chip block 2 and the interface node 4 will use a handshake protocol 8 to control the communication there between. A handshake can be considered to have two or more signals that consist of a request or initialization from a master (initiator—e.g. the SoC block), and an acknowledgement or grant from a slave (e.g. the interface node). There may be signals travelling both ways to obtain a valid handshake. The handshake protocol may be any suitable protocol, for example a request/grant protocol. The system on chip block may provide a request to the interface node 4 and the interface node 4 will provide a grant response to that request.

The system on chip block 2 will provide data 10 to the interface node. The data may comprise one or more of address information and data which is to be provided to the address identified by the address data 10. The address may be a memory location to be addressed. The memory may be one or more of physical memory (e.g. off chip RAM (random access memory), flash, on-chip RAM/ROM (read only memory)/FLASH), on-chip register space, and on-chip peripheral access space mapping to external locations. The address information may be provided by the system initiator (or master). This may be the system on chip block and/or debug block. The data may be information to be written, or read from the selected address.

The system on chip block 2 may also provide transaction information 14 such as transaction type and/or size. This may represent the amount of data to be transferred and/or the type of operation (e.g. read/write or a more complex operation). This may be provided by opcode information and/or may be part of the data 10.

The system on chip block 2 may send transaction termination information 16. This may provide an indication from the initiator that indicates the end of a given transaction (or burst of data). In some embodiments, the transaction termination information may comprise one or more of end of packet (eop) information, not end of chunk (Ick) information and not end of message (msg) information. Alternatively or additionally, the transaction termination information can be any other suitable transaction termination information. The transaction termination information may be dependent on the protocol used. In some embodiments, transaction termination information may be provided by a single bit which is either asserted or not, as required. Other embodiments may use two bits or more for the termination information.

As discussed above, the transaction termination information may comprise eop information which may be used to indicate the last cell in a packet or the end of a packet. A cell may be regarded as being a smallest component of a transaction and may be a single valid clock cycle of data transfer. A packet may be a defined amount of data made up of a number of valid cells. In some protocols, a packet is sometimes referred to a burst. The Ick information may be used to indicate packets that are linked together, in a chunk. The msg information may indicate that the packet is part of a message, where a message provides the largest or larger bus transaction.

Other signals may optionally be provided, either in addition or in the alternative.

A transaction may be considered to be the transfer of a defined amount of data across an interface taking one or more clock cycles. The transaction may be a cell, packet, chunk, message, burst or multiple burst. Some protocols refer to two or more bursts as an atomic transaction.

In some embodiments, a transaction may be a collection of active (where data is transferred from master to slave) bus clock cycles that are linked. This may be a collection of cycles that make up a burst of data, a linked set of data bursts, or a sequential address access. Alternatively or additionally, a transaction could also be a single active cycle access. A transaction may have a termination signal or signals. The transaction may be split into a request transaction (e.g., started by the system on chip block), and a response transaction (e.g. started and/or from the interface node as a result of the request transaction).

It should be appreciated that the transfer of information between the system on chip block 2 and the interface node 4 will be determined by the protocol used. The protocol may be the STBus protocol (which has been developed by the applicant), AXI—advanced extensible interface (which has been developed by ARM) or any other suitable protocol.

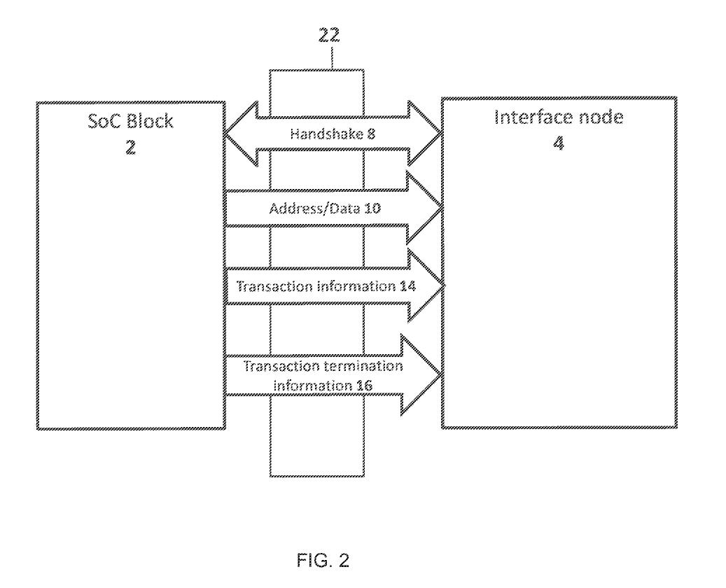

Reference is made schematically to FIG. 2 which shows an embodiment. The arrangement of FIG. 2 differs from that of FIG. 1 in that a debug block 22 is provided between the system on chip block 2 and the system on chip interface node 4. The debug block is configured to provide one or more different functionalities.

In some embodiments, the debug block may provide a capability to manipulate a transaction.

The debug block may provide one or more of the following functions:

hold off a request indefinitely. This may be used if during a debug operation, a functional block is flooding the system with data;

apply n wait cycles to slow the requests made to the system. In some embodiments, n may be a fixed value and in other embodiments may be varied;

wait for a specific address and/or data to be presented to the debug block and then hold off the request associated with that specific address and/or data;

hold off a transaction being presented to the bus. This can be then released to the system for 1 to x cycles before the transaction is stopped again. In some embodiments, x may be a fixed value and in other embodiments may be varied;

override some or all of the data and/or addresses being presented then release the functional block for just one cycle, two or more cycles or indefinitely; and

close transactions which are open.

It should be appreciated that the debug block may be able to do one, some or all of the above functions. It should be appreciated that in some embodiments, the debug block may be able to manipulate or change the communication between the system on chip block and the interface node. The manipulation may for example change the transaction itself, change the timing of the transaction, and/or stop the transaction.

In some systems, system lock up may be due to the incorrect configuration of one or more system on chip blocks and/or bugs in one or more system on chip blocks. For example this may cause one or more transactions not to be terminated. Some embodiments may allow the system on chip block causing the problem to be identified more easily and/or may make the debug process simpler to do, requiring less time.

Thus, the debug block 22 of some embodiments is configured to manipulate one or more transactions between the system on chip block 2 and the interface node 4. When the debug block 22 is inactive, all signals will pass between the system on chip block 2 and the interface node 4. In some embodiments, there may be no timing changes resulting from the presence of the debug block when that block is inactive, meaning that there is no latency impact. Thus transactions may thus pass transparently through the debug block when the debug block is inactive.

In some embodiments, once activated, the debug block 22 will be transparent to the system until a manipulation is required or activated.

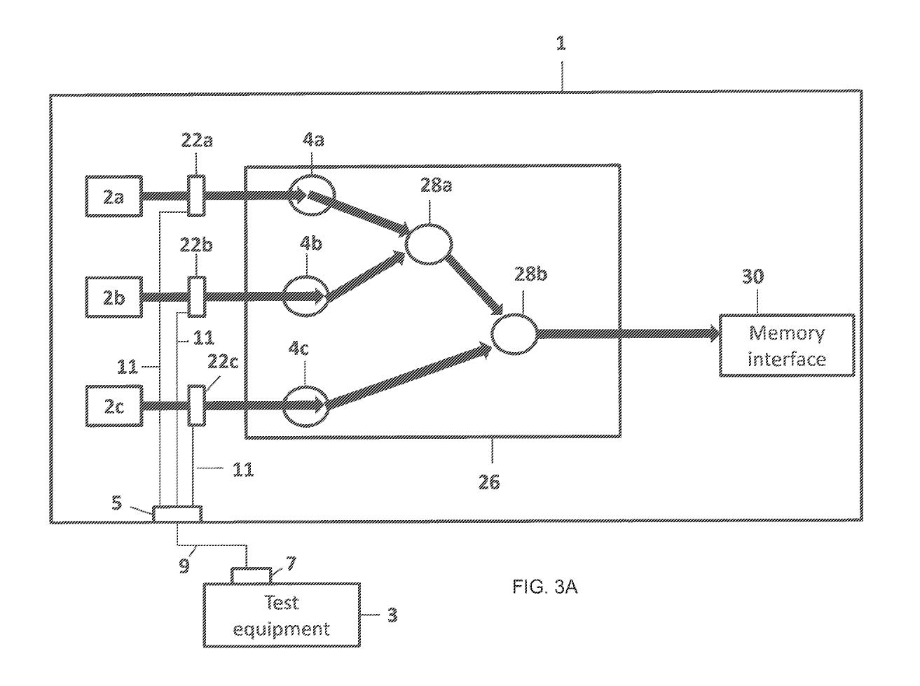

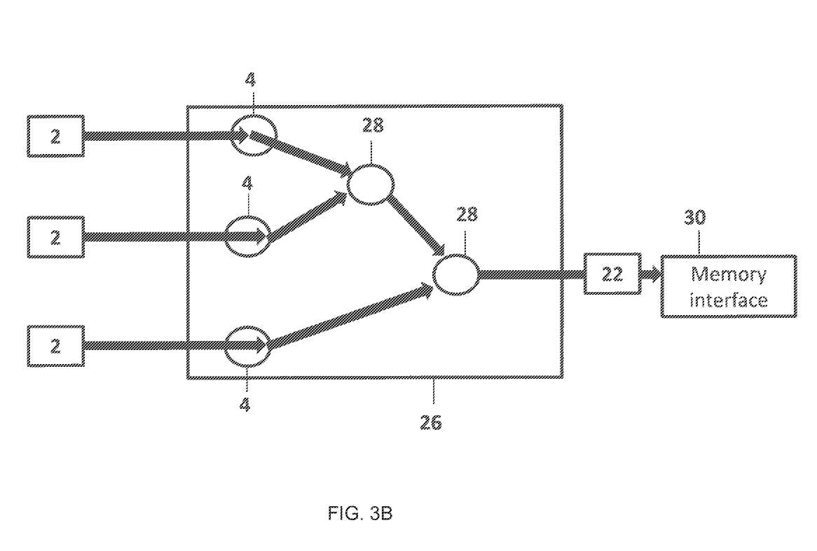

Reference is made to FIG. 3A which schematically shows an integrated circuit or die 1 and external test equipment 3. The external test equipment has an interface 7 and the integrated circuit or die 1 has an interface 5. The interfaces 5 and 7 are connected via a connection 9. The interfaces may be bidirectional interfaces. One or both of the interfaces may be provided by one or more pins. The integrated circuit or die has three system on chip blocks 2a, 2b and 2c. Each system on chip block is provided with its own debug block 22a, 22b and 22c. Associated with each system on chip block 2a, 2b and 2c is a respective interface node 4a, 4b and 4c. It should be appreciated that in other embodiments, more or less than three system on chip blocks may be provided.

In some embodiments, the interface 5 may comprise one or more pins which are used to otherwise interface to the integrated circuit or die. It should be appreciated that the interface may be dedicated for interfacing with the test equipment or a shared interface.

In some embodiments, no test equipment is used. For example, some embodiments may be used to provide a work around to deal with an issue with an integrated circuit or die.

It should be appreciated that in other embodiments, a CPU or the like may be configured to provide an on-chip test function in addition or as an alternative to the external test equipment. In some embodiments the CPU or the like may provide a debugging function and the CPU may provide an output to test equipment.

In some embodiments, a debug block may be shared by two or more system on chip blocks.

In some embodiments, more than one system on chip block may be associated with the same interface node.

In some embodiments, one system on chip block may be associated with two or more debug blocks.

The interconnect, of which the interface node(s) is/are part, is schematically referenced by numeral 26. Within the interconnect 26 are additional interconnect nodes 28a and 28b. These additional interconnect nodes 28a and 28b may be downstream of the interface nodes 4. Generally one or more or all of the nodes of the interconnect can be considered to be an interface arbitration component. The number of interconnect nodes may be more or less than the five shown in FIG. 3A.

In the example shown in FIG. 3A, the destination for the transactions from the system on chip blocks 2 is a memory interface 30. However, it should be appreciated that this is by example only and the destination may be any other suitable destination. In some embodiments, there may be more than one destination.

The debug blocks are arranged to communicate with the interface 5 via a communication path schematically referenced 11. It should be appreciated that the communication path may be a dedicated path or may at least partially be provided by the interconnect 26.

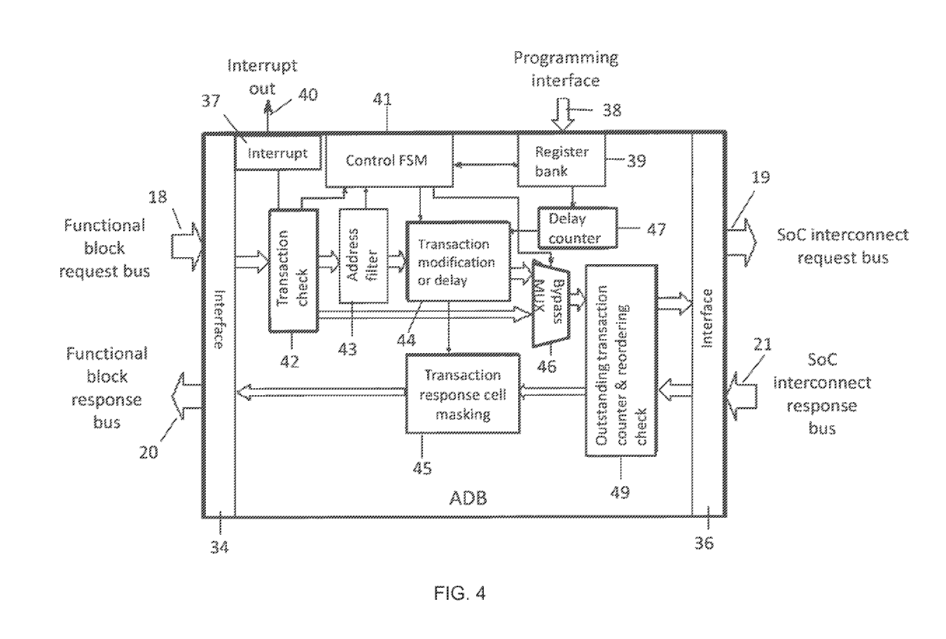

Reference is made to FIG. 4 which schematically shows the debug block 22 in more detail. The debug block has a first system on chip block interface 34 for receiving transactions 18 from the system on chip block 2 and for providing responses 20 to the system on chip block. The debug block has a second interconnect interface 36 for outputting transactions 19 to interface node 4 and for receiving responses 21 from the interface node 4.

The debug block has a register programming interface 38. The debug block may be programmed by a system master either during boot or at any point using debug access techniques. The debug block had a register bank 39 which contains configuration information for controlling the debug block.

The debug block has interrupt generation circuitry 37 which is configured to generate, when necessary, an interrupt which is output via interrupt output 40. When alerting the user or test equipment to a problem an interrupt will be raised and/or a register status bit. The interrupt and status bit may be cleared by writing to a clear bit.

The register bank or other suitable register may record the nature of the alert (e.g. illegal transaction, time-out, or counter limit reached). Interrupts may be wired to external chip interrupt lines.

The debug block has a control finite state machine FSM 41. The control FSM is configured to receive configuration information from the register bank 39. The control FSM 41 is configured to operate in dependence on the configuration information. The debug block also has a transaction check function 42 which is configured to receive input transactions from the first interface 34. The transaction check function 42 is configured to provide an output to the interrupt generation circuitry 37. The transaction check function 42 is also configured to provide an output to the control FSM 41. If a transaction is to pass transparently through the debug block, the transaction is passed directly to a bypass multiplexer 46. Otherwise, the output of the transaction check function 42 is provided to an address filter function 43.

The address filter function 43 is configured to provide an output to the control FSM 41. The transaction is then provided to a transaction modification or delay function 44. The control FSM is configured to provide an output to control the transaction modification or delay function 44. The output of the transaction modification or delay function 44 is provided the bypass multiplexer 46. The bypass multiplexer 46 is controlled by the control FSM 41 to select one of its inputs as an output, depending on the mode of the debug block. If the debug block is to pass the transactions transparently through the debug device, the bypass multiplexer will select the output from the transaction check function. If the debug block is to manipulate the transaction, the output of the transaction modification or delay function 44 is output by the bypass multiplexer.

The output of the bypass multiplexer 46 is input to an outstanding transaction counter and re-ordering check function 49. The transaction, which may or may not be modified depending on the mode of the debug block, is then output to the second interface 36.

A delay counter 47 is also provided which is controlled by an output of the register bank 39. The output of the delay counter is used by the transaction modification or delay function 44, in some applications or embodiments. It should be appreciated that the outstanding transaction counter and reordering check function 49 may also be configured to receive transaction responses from the interface node. The outstanding transaction counter and reordering check function 49 will provide the responses to a transaction response cell masking function 45. This may be controlled by the transaction modification or delay function 44. The response, if not masked, will be provided to the first interface 34 for output back to the system on chip block 2.

It should be appreciated that the blocks shown in FIG. 4 are for schematic purposes and may be implemented by circuitry, hardware, software or a combination of two or more of the above. In some embodiments, some circuitry may be shared by one or more of the functions. In some embodiments, one or more of the functional blocks may be omitted, depending on which one or more modes are supported by the debug block.

Different functional modes may be first set up for example when the debug block is idle. This may be done via the programming interface 38. The programming interface may receive data from the test equipment. This may be done when there is no traffic passing through. Once the register bank 39 has been configured, the debug block may be activated and the debug block will enter one of the following functional modes. It should be noted that the debug block may be capable of supporting only one of the functional modes, some of the functional modes or all of the functional modes discussed.

During the idle (or bypass) mode, the debug block does not interfere with the data passing through. The second interface 36 mirrors what is presented on the first interface 34 and vice versa, with a zero clock cycle delay. This path would be via the transaction check function 42, to the bypass multiplexer 46 and through the outstanding transaction counter and reordering check function 49. The transaction would be transparently passed through these functions. In this mode the programming interface 38 is still accessible and settings can be programmed in the register block, but these settings have no effect until the block is enabled. The idle mode may be the default mode following reset. Thus, in this mode, the debug block does not change, monitor, or alert to problems with transactions. The bus access may directly feed through the debug block with no delay.

When set in an alert only mode, the debug block will perform no manipulation action and will simply notify the system of one or more events by setting an internal register bit and/or generating an interrupt. Thus, in this mode the debug block does not change or delay any bus accesses but alerts the test equipment by raising an interrupt and/or setting a register bit that, for example, an illegal transaction has occurred.

Alert pause mode: this is similar to the alert mode except that the bus requests from the system on chip block are stopped until the user or test equipment intervenes.

In the transaction close mode, the debug block will attempt to close an open transaction once the programmed timeout setting has been reached. The types of transactions which the debug block 22 will close may be configured via its register bank. An interrupt and/or status bits may also be optionally set. In this mode, the debug block may alert the test equipment to the illegal transaction (e.g. via an interrupt), and/or insert a closing transaction after a set time-out limit defined by the delay counter has occurred (defined by the register bank). The debug block may also activate the outstanding transaction counter 49 to correctly mask out any extra response data information that may have occurred as a result of the debug block creating extra request information. Note that if the debug block can correct the transaction without adding extra cycles (i.e. just activating a termination signal), then there may be no response transactions to mask out.

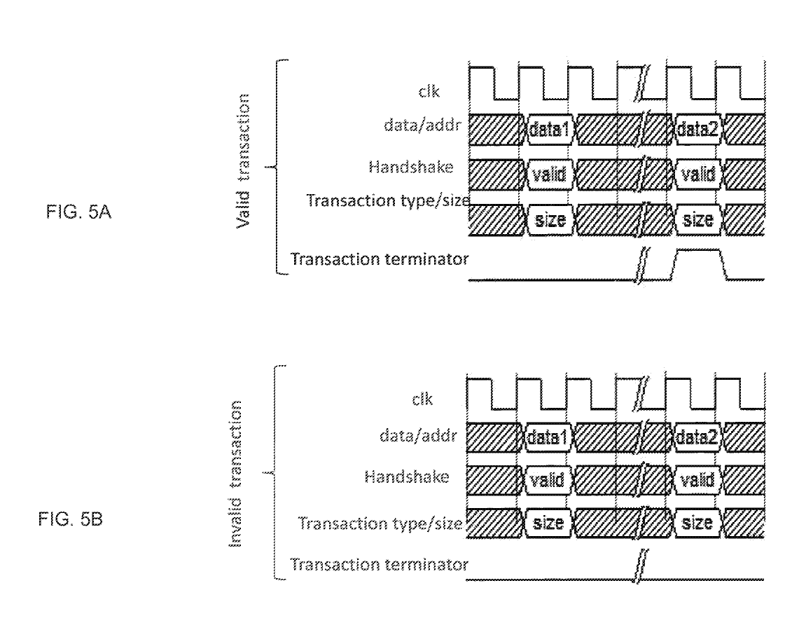

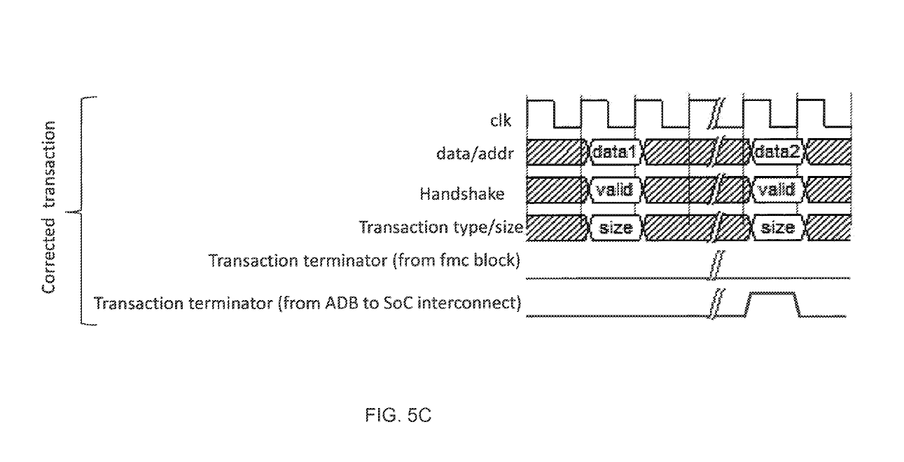

When closing a transaction, the debug block may generate a single cell asserting/de-asserting the appropriate one or more signals for the type of transaction it is closing. See for example FIG. 5C. This cell will be presented at the output interface 36 of the debug block to close the open transaction.

In the case of some protocols, if the debug block is configured such that two or more open transaction types reach their time-out values simultaneously or generally at the same time, then it is possible for the debug block to close all of them in a single generated cell simultaneously or generally at the same time asserting/de-asserting all the relevant signals.

In some bus architectures a request transaction may result in a system generated response transaction. In the case of a write it may be a single cell response that confirms the write command has reached the system target. For reads, the response will consist of one or more cells containing the data requested. Although the debug block may have potentially prevented a system lockup, allowing the responses resulting from the extra transaction closure cells from propagating back to the system on chip block could cause further issues.

If new requests are not generated by the system on chip block until responses are received, then any responses from the interface node that occur after the debug block has triggered are stopped. However, some system on chip blocks will generate two or more requests without having all the responses. This is known as an outstanding request, where a request has been made for which there has not yet been a response.

To enable the debug block to manage this scenario, the outstanding transaction counter and reordering check function of the debug block may keep track of the number of outstanding requests made by the system on chip block(s) and use this to work out the number of response cells expected. The memory space required for this may be relatively small, since the actual request data may not be stored in some embodiments, just the type and size of request. The outstanding transaction counter may be decremented as response cells are received through the debug block from the interface node.

When the debug block is triggered and issues a transaction closing cell, the index or count of the outstanding transaction counter is sampled and stored. Response cells from the interface node are then counted until the counter value equals the stored request counter value. At this point the next response cell was due to the debug block generated transaction closing cell. This response cell may not be presented back to the system on chip block.

In parallel, the outstanding transaction counter may be incremented and decremented accordingly as request and response packets pass through the block. This allows the total number of outstanding requests to be known at any point in time.

The debug block may take into account the bus protocols asymmetric nature, i.e. that a write request may have more cells than its corresponding response and vice versa for a read request.

In some embodiments, the cells contain information to indicate their transaction size and whether they are read or write. Some embodiments may take into account possible out-of-order responses caused by multiple transaction identities used.

Transaction close pause mode: This is similar to the transaction close mode except that the debug block will correct the transaction then stop bus requests from the system on chip block, and wait for user or test equipment intervention

The following modes which will now be described are where the debug block is configured to change the timing.

Pause mode: when set in this mode, the debug block will pause any active transactions on the link. This is achieved by de-asserting at least part of the handshake signal (for example the grant signal). When released, by writing to a configuration register, the debug block will return to the selected mode. In this mode the debug block may stop bus accesses from the system on chip block from reaching the interface node. The transaction is not lost but held off. This mode can be entered immediately, or after a predefined number of clock cycles (pause countdown mode) as determined by the delay counter. The debug block may not release the bus until the user or test equipment intervenes.

Pause countdown mode: the debug block remains inactive but the delay counter counts clock cycles. Once a programmed limit is reached the debug block pauses the system on chip block traffic. The debug block is released in the same way as with the pause mode.

Pause address trigger mode: the debug block remains inactive but the address filter function checks the incoming address. When the address matches a pre-set value the debug block immediately pauses the system on chip block traffic. The debug block is released in the same way as with the pause mode. In this mode the bus accesses are stopped if an address is seen that matches a user or test equipment specified address programmed via the register bank. The debug block will not release the bus until the user or test equipment intervenes.

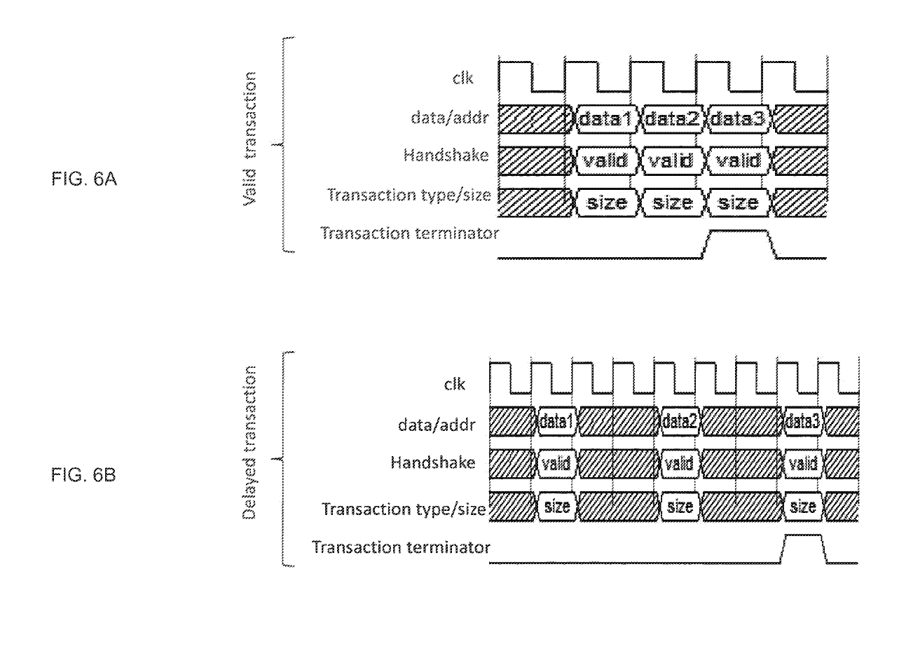

Bandwidth throttle mode: this mode (described in more detail later with reference to FIG. 6B) may help debug systems where certain functional blocks are generating lots of traffic and interfering with other system on chip block operation. In some embodiments, the delay counter is used to allow the number of paused cycles to be set. That counter may be used to control the number of active cycles. In some embodiments, two counters may be provided. The debug block may continually switch from one state to the other when the respective count limit is reached. In this mode the debug block will insert wait (or idle) cycles to slow down the bus accesses from the functional block. This slowing down does not slow down the clock in some embodiments, but rather the system on chip block access is held off for a number of cycles (defined by a user or test equipment programmed register) before releasing the bus access. This may continue indefinitely until a new mode is selected or the block is reset.

Address override mode: in this mode, data is re-directed to a programmed address rather than the address presented by the system on chip block. This mode is useful to put data that has been generated by the system on chip block into a visible memory. The address can be fixed or incremented automatically. This mode may be useable with one or more other modes including the idle mode.

Data Override mode: In this mode, the data is modified to a programmed value, with the address being left unchanged. This may be useful when certain data is causing corruption or other problems at the target. This mode may be used in conjunction with other modes, including the idle mode.

The debug block may be used to carry out one or more different manipulations.

Consider the following example which will now be explained with reference to FIG. 3A. In this example the traffic (or requests) have been generated from each system on chip block 2a, 2b and 2c. A second of the system on chip blocks 2b has made its request first so has been given access through the arbiters of the interface nodes to the memory interface 30. All three system on chip blocks 2a, 2b and 2c have made requests to the memory interface, so will converge on the common path to the memory interface. To make the interface as efficient as possible, any single transaction from a given system on chip block is kept together when that transaction spans more than one cell or active clock cycle. For this reason the arbiters of the interface nodes will keep open the path from the second system on chip block 2b to the memory interface 30 until the transaction is complete. If the transaction is not closed, the interface nodes 28a and 28b will have their arbitration locked to the system on chip block 2b with the open transaction. This may stall the system on chip block. Additionally or alternatively, this may block the other two system on chip blocks 2a and 2c from accessing the memory interface. A system lockup may not immediately occur, but is increasingly likely if the scenario continues.

Other system on chip blocks may get starved of data causing exceptions or crashes, which can still happen even if the second system on chip block does close its transaction, but only after a significant number of clock cycles. This sort of transaction can be caused when the system on chip block is generating data from an internal process at a rate slower than the interface node is capable of receiving that data. The resultant transaction would consist of a few cells followed by a large number of idle cycles interleaved with valid cells, after which the transaction is finally closed.

In the some embodiments, the terms valid cells or valid cycles will be used to describe the situation where a request is granted by the interconnect node resulting in a transfer of data to the next interconnect node or destination. The protocol for this will be dependent on the relevant bus standard or bus design.

An open request is a request made by the system on chip block that has not yet been granted by the interface node. An open transaction may contain one or more closed requests, but without the final transaction closing request.

In some bus protocols, a packet is the transfer of a complete opcode split up into one or more valid cycles called cells. An example is a store 64 which is a 64 byte write to a system slave interface (e.g. memory interface). If the data width of the interface is 8 bytes wide (64 bit), then a store would take 8 valid cells to transfer. The last cell in the transfer should assert the ‘end of packet’ bit (EOP) or similar transaction terminator, for it to be a legal transaction. In some protocols, a read request (load, LD) will only consist of a single cell no matter what the data bus or opcode size.

Reference is made to FIGS. 5A, 5B and 5C. In all of these timing diagrams, the clock signal clk is shown on the first line along with the data and/or address cells data/addr on the second line. In this example, the data/address data comprises two cells, data 1 and data 2. In this example, the transaction comprises two data cells. The handshake protocol is shown on the third line in all three timing diagrams. A valid signal coincides with data 1 and data 2. Also shown on the fourth line is the transaction type/size, in all three timing diagrams. The size information coincides with data 1 and data 2.

For the last cell, the transaction terminator signal, as show on the fifth line of FIG. 5A, is high, coinciding with data 2, indicating that the last cell of the transaction is being transferred. This signal will terminate the transaction. Thus, FIG. 5A shows an example where the packet is correctly terminated.

Consider the following examples:

if the transaction termination signal is not asserted on the last cell, the transaction would be an illegal transaction as well as being an open transaction: and

the last cell (with the transaction termination signal not asserted) is never presented to the interface node and the arbiters would wait indefinitely for the last cell.

FIG. 5B shows an example where the transaction termination signal is not asserted. In the fifth line, the transaction termination signal remains low as it is not asserted. The interface node will wait for the final cycle in the transaction where the transaction termination signal goes high.

FIG. 5C shows an example where the debug block provides a termination signal. This is shown on line 6. This termination signal provided by the debug block is treated by the interface node as if the termination signal has been provided by the system on chip block. This is the transaction close mode.

In the above, the transaction termination signal is only asserted for the last cell. In other embodiments, the transaction termination signal is asserted for the transaction, other than for the last cell in which the transaction termination signal is de-asserted. It should be appreciated that a signal may be asserted high or asserted low.

Some examples of situations with different transaction termination signals will now be discussed.

This end of transaction signal may be an end of packet or end of transaction signal. In some embodiments, this signal may be asserted at the end of a transaction or packet.

In some protocols, a chunk is defined as a series of packets linked together by a lock signal (Ick). The chunk may be any number of packets long, with the whole of the last packet within the chunk having the Ick signal de-asserted. Some networks can optionally keep chunks together to help with efficiency, so a potential lockup could occur if a chunk was not terminated.

Some examples of potential problems are:

the Ick signal is not de-asserted on the last packet, resulting in an open transaction causing the system on chip interconnect arbiters to wait for the next or last packet;

the Ick signal is de-asserted only for the first cell of the last packet, and then is asserted again. This would cause unknown behavior and would depend on the interface node component processing the packet, either accepting it as closed or leaving it as an open chunk; and

the Ick signal de-asserted only for the last cell of the last packet. This would result in potentially unknown behaviour in the interface node.

In some embodiments, the largest transaction type may be a message. A message may consist of two or more chunks, where the chunks could be single packets (Ick bit may not get asserted), so it is possible to consist just of packets. The message signal (msg) is asserted for all chunks and then de-asserted on the last one.

Some examples of potential problems are:

the msg signal is not de-asserted for the last chunk, resulting in an open transaction causing SoC interconnect arbiters to wait for the next chunk;

the msg signal is de-asserted only for the last packet of the final chunk (where the chunk is larger than one packet) or the last cell in the message. This would cause unknown behaviour and would depend on the interface node processing the message, either accepting it as closed or leaving it as an open message;

the message signal is de-asserted only for the first packet of the final chunk, or the first cell of the final chunk. This may result in potentially unknown behavior in the interface node.

It should be appreciated that the different terms may be used to describe equivalent transactions and signals, depending on the protocol used.

In the ARM AXI3 protocol, an AXI burst (similar to a packet) is normally terminated with an RLAST (read) or WLAST (write) signal assertion (similar to the eop). If this is not asserted on the last transfer of the burst then an open transaction will result. WLAST may be asserted from the system on chip block. Similar problems may occur if WLAST is not asserted as described in relation to the eop signal.

There are two types of atomic transactions in the AXI protocol, exclusive and locked. They are controlled by the ARLOCK and AWLOCK signals.

Locked Atomic Transactions are similar to a chunk in that they provide a way for the master system on chip block to have exclusive access to a target until the transaction completes. Unlike a normal read burst, an open locked read is possible as well as an open locked write. Similar problems may arise if the AWLOCK or ARLOCK signals are not put into the end of transaction state at the end of the transaction.

Illegal transactions which result in an open transaction may be detected by the debug block in some embodiments.

Some embodiments may thus provide the necessary signalling to end a transaction.

In FIGS. 6A and 6B, the first line of the timing diagram shows the clock signal. In this example, the transaction comprises three data cells, data 1, data 2, and data 3. The handshake protocol is shown on the third line. A valid signal respectively coincides with data 1, data 2 and data 3. Also shown on the fourth line is the transaction type/size. The size information coincides with data 1, data 2 and data 3.

For the last cell, the transaction terminator signal, as shown on the fifth line of FIG. 6A, is high, coinciding with data 3, indicating that the last cell of the transaction is being transferred. This signal will terminate the transaction. Thus FIG. 6A shows an example where the packet is correctly terminated.

FIG. 6B shows a similar situation to the arrangement of FIG. 6A but in which data 2 has been delayed by the debug block with respect to data 1 and data 3 has been delayed with respect to data 2. The handshake signaling, transaction type/size signaling and transaction terminating signaling have been likewise been delayed. The data may be part of the same transaction or different transactions. The debug block thus delays the timing of signaling from the system on chip block.

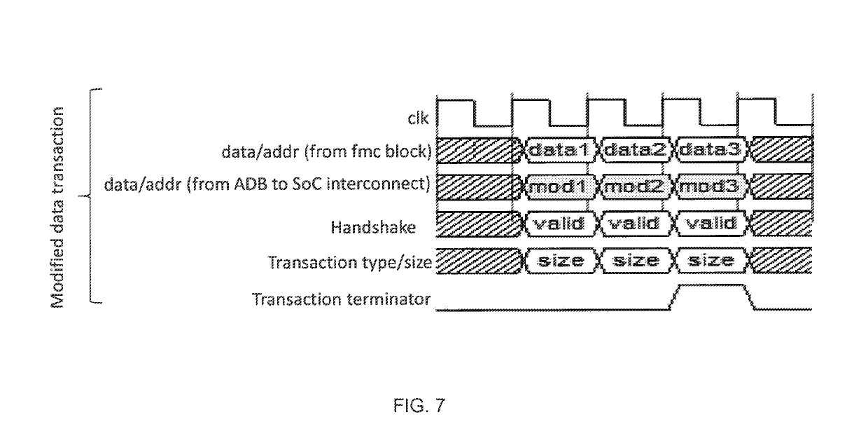

Reference is made to FIG. 7. In this timing diagram, the clock signal clk is shown on the first line along with the data and/or address cells data/addr on the second line. In this example, the transaction comprises three data cells, data 1, data 2, and data 3. In this embodiment, the debug block modifies the data cells and instead will output the modified data cells mod 1, mod 2 and mod 3 to the interface node. This is shown on the third line. The modified data has the same timing as the unmodified data in some embodiments.

The handshake protocol is shown on the fourth line. A valid signal respectively coincides with data 1, data 2 and data 3. Also shown on the fifth line is the transaction type/size. The size information coincides with data 1, data 2 and data 3. For the last cell, the transaction terminator signal, as show on the sixth line of FIG. 7, is high, coinciding with data 3, indicating that the last cell of the transaction is being transferred. This signal will terminate the transaction. In some embodiments, the modified data may have a different timing with respect to the original data.

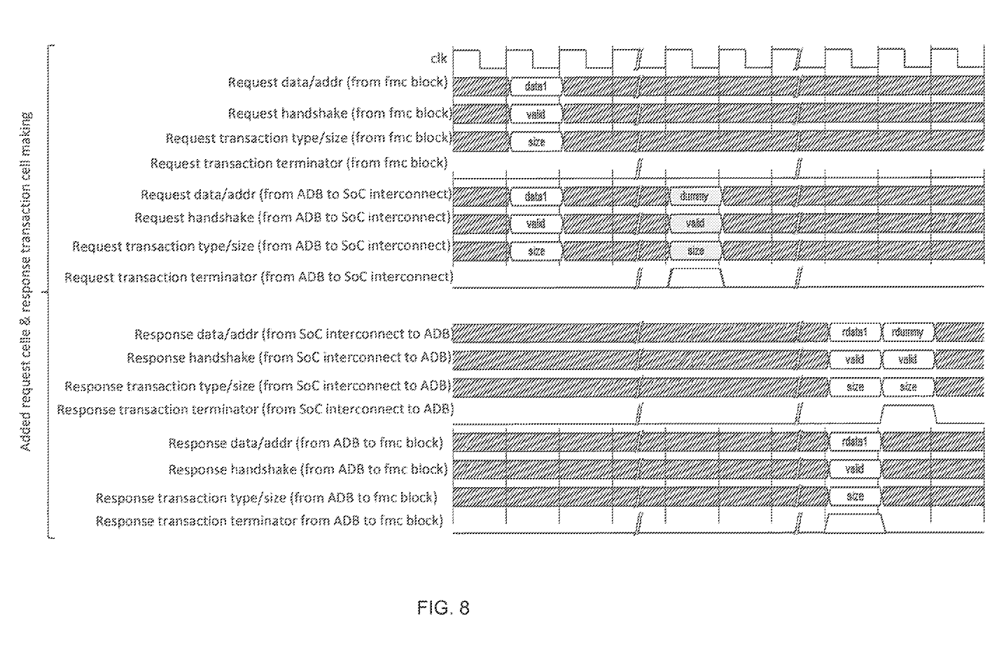

Reference is made to FIG. 8. In this timing diagram, the clock signal clk is shown on the first line along with the data and/or address cells data/addr on the second line. In this example, the data/address data comprises one cell, data 1. The handshake protocol is shown on the third line. A valid signal coincides with data 1. Also shown on the fourth line is the transaction type/size. The size information coincides with data 1. The fifth line is the transaction termination signal line and this has no asserted signal. The signals shown on the second to fifth lines are received by the debug block from the system on chip block.

The sixth to ninth lines of the timing diagram show the signaling output by the debug block to the interface node. The sixth line shows data and/or address cells data/addr. This has the cell received from the system on chip block, data 1 and a second cell, dummy, which is provided by the debug block. The handshake protocol is shown on the seventh line. A valid signal coincides with data 1 and with the dummy data. Also shown on the eighth line is the transaction type/size. The size information coincides with data 1 and with the dummy cell. The ninth line is the transaction termination signal line and this has no asserted signal for data 1 but has an asserted signal for the dummy cell. The debug block will provide the signaling which is associated with the dummy cell.

The tenth to thirteenth lines of the timing diagram show the response received by the debug block from the interface node. The tenth line shows the response data and/or response cells, one responding to data 1 and one responding to the dummy cell. The eleventh line shows the handshake protocol. A valid signal coincides with the response to data 1 and the response to the dummy data. Also shown on the twelfth line is the transaction type/size. The transaction size/type information coincides with data 1 and with the dummy cell. The thirteenth line is the transaction termination signal line and this has no asserted signal for data 1 but has an asserted signal for the dummy cell.

The remaining lines of the timing diagram show the response signaling provided by the debug block to the system on chip block. The debug suppresses all the responses relating to the dummy cell. Thus the fourteenth line shows the response data corresponding to data 1 and none responding to the dummy cell. The fifteenth line shows the handshake protocol. A valid signal coincides with the response to data 1. Also shown on the sixteenth line is the transaction type/size. The transaction size/type information coincides with data 1. The final line is the transaction termination signal line and this has an asserted signal for data 1 (this is from the dummy data but has been moved to be associated with data 1).

In some embodiments a grant or ready signal from the SoC interconnect is continually asserted. However, in other embodiments this signal could toggle causing the system on chip block transaction to pause until the SoC interconnect is ready for the next cell.

Some embodiments may improve debugging and/or speed up the time to diagnose problems with system on chip blocks.

Some embodiments, may allow the system to remain running. This may be with corrupt data.

Some embodiments may allow the determination if any function block has an open transaction. This may be determined by looking at the debug blocks to see if they have been triggered and/or by looking for an interrupt which is has been generated by a debug block.

Some embodiments allow a determination as to which system on chip block or blocks were in operation when a lock up occurs.

In the above described embodiments, a signal is described as having a particular signal level when asserted. It should be appreciated that this is by way of example only and in other embodiments, one or more signals may have a different level when asserted. The interconnect may take any suitable form and may be a bus or a network on chip.

The debug block may be provided, alternatively or additionally at any other suitable location. By way of example only, reference is made to FIG. 3B. Those elements which are the same as in FIG. 3A are referenced by the same reference number. As can be seen the debug block is provided downstream of the interconnect 26 and upstream of the memory interface 20. No test equipment is shown. Any of the test equipment options discussed in relation to FIG. 3A may be provided here. Of course there may be no test equipment in some embodiments.

The system on chip block 2 may provide any suitable function or logic block. The system on chip block may be an initiator. The system on chip block may be an interface block, for example a network interface or the like.

All of the various blocks shown in the figures may be implemented by circuitry, hardware, software or a combination thereof.

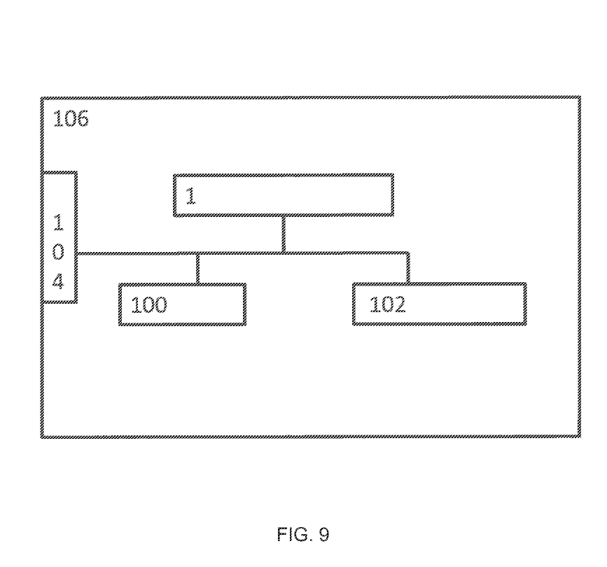

Reference is made to FIG. 9 which schematically shows a device 106 according to an embodiment. The device 106 comprises an integrated circuit or die 1 such as described previously. In other embodiments, the integrated circuit or die may be alternatively be provided by one or more integrated circuits, one or more dies or a combination of one or more dies and one or more integrated circuits. The device may optionally have an interface 104. This may be for receiving data and/or for outputting data, depending on the application of the device. The device may have one or more other function blocks. In the example shown in FIG. 9, two function blocks 100 and 102 are provided. Those function blocks may provide any suitable function and might be an image display function, an audio output function, a computational function, a data processing function, a radio frequency function, a receiver function, a transmitter function, an antenna function, a data input function, a memory function or any other suitable function

A device of some embodiments may be any suitable device as embodiments may have a wide range of applications. Some device embodiments may be consumer electronics applications such as mobile phones, tablets, computers, smart phones, set top boxes, music players, DVD players, media players, streaming devices, home gateway boxes, cable modem, Blu-Ray devices, displays, televisions or any other suitable device.

All of the various blocks shown in the figures may be implemented by circuitry, hardware, software or a combination thereof.

While this detailed description has set forth some embodiments of the present invention, the appending claims cover other embodiments of the present invention which differ from the described embodiments according to various modifications and improvements. Other applications and configurations may be apparent to the person skilled in the art.

What is claimed is:

1. A debug circuitry, comprising:
a first interface configured to receive at least one operational transaction;
a second interface configured to provide an output; and
transaction manipulation circuitry configured to perform a manipulation operation on at least one operational transaction to provide a manipulated operational transaction output to said second interface, said manipulated operational transaction output comprising said output.

2. The debug circuitry as claimed in claim 1, wherein said transaction manipulation circuitry is configured to change a timing of said at least one operational transaction.

3. The debug circuitry as claimed in claim 2, wherein said transaction manipulation circuitry is configured to one of pause said at least operational transaction and delay said at least one operational transaction.

4. The debug circuitry as claimed claim 1, wherein said transaction manipulation circuitry is configured to add an end of transaction termination signal to said operational transaction.

5. The debug circuitry as claimed in claim 1, wherein the transaction manipulation circuitry is configured to change at least one of an address or data content of said operational transaction.

6. The debug circuitry as claimed in claim 1, wherein the transaction manipulation circuitry is configured to add dummy transaction information to said operational transaction.

7. The debug circuitry as claimed in claim 6, wherein said dummy transaction information comprises dummy data and associated information.

8. The debug circuitry as claimed in claim 1, wherein said second interface is configured to receive at least one response transaction, said transaction modification circuitry is configured to modify the response transaction to provide a modified response transaction to said first interface, said first interface being configured to output said modified response transaction.

9. The debug circuitry as claimed in claim 8, wherein the transaction manipulation circuitry is configured to add dummy transaction information to said operational transaction, and wherein said transaction modification circuitry is configured to modify the response transaction to remove a response to said dummy transaction information.

10. The debug circuitry as claimed in claim 1, wherein said transaction manipulation circuitry is configured in one mode of operation to pass the at least one operational transaction with no manipulation to the second interface.

11. The debug circuitry as claimed in claim 1, further comprising an input configured to receive configuration information for configuring said debug circuitry.

12. The debug circuitry as claimed in claim 1, further comprising an output configured to output debug information for test equipment.

13. The debug circuitry as claimed in claim 1, wherein the debug circuitry is provided on a die or integrated circuit.

14. The debug circuitry as claimed in claim 13, further comprising an interconnect, a transaction source and a destination for said manipulated operational transaction output.

15. The debug circuitry as claimed in claim 14, wherein said debug circuitry is provided in a path between said transaction source and said interconnect.

16. The debug circuitry as claimed in claim 14, wherein said debug circuitry is provided in a path between said interconnect and a destination for said manipulated operational transaction output.

17. A device, comprising:
a transaction source;
a destination;
an interconnect between the transaction source and the destination, said interconnect supporting debug circuitry;
wherein the debug circuitry comprises:
a first interface configured to receive at least one operational transaction from said transaction source;
a second interface configured to provide an output towards said destination; and
transaction manipulation circuitry configured to perform a manipulation operation on said at least one operational transaction to provide a manipulated operational transaction output to said second interface, said manipulated operational transaction output comprising said output.

18. The device of claim 17, wherein the manipulation operation performed by said debug circuitry comprises pausing a transfer of data for said at least one operational transaction.

19. The device of claim 17, wherein the manipulation operation performed by said debug circuitry comprises notifying test equipment of the occurrence of an event associated with the at least one operational transaction.

20. The device of claim 17, wherein the manipulation operation performed by said debug circuitry comprises changing a target address or content of data being transferred in said at least one operational transaction.
